(19) United States
(12) Patent Application Publication
(10) Pub. No.: US 2020/0159209 A1
(43) Pub. Date: May 21, 2020

(54) DRONE TRACKING STEERED ANTENNA SYSTEM

(71) Applicant: Taoglas Group Holdings Limited, San Diego, CA (US)

(72) Inventor: Carlos Francisco Montoya-Mejia, Spring Valley, CA (US)

(21) Appl. No.: 16/657,830

(22) Filed: Oct. 18, 2019

Related U.S. Application Data
(60) Provisional application No. 62/747,213, filed on Oct. 18, 2018.

(51) Int. Cl. G05D 1/00; G08C 17/02; H04W 16/28; H04W 84/00; H04W 4/029; H04W 64/00; H04W 4/02; B64C 39/02

(52) U.S. Cl. CPC G05D 1/0016; G08C 17/02; H04W 16/28; H04W 84/005; H04W 4/029; G08C 2201/42; H04W 4/026; B64C 39/024; G05D 1/0022; B64C 2201/146; H04W 64/006

(57) ABSTRACT

A system for tracking an unmanned aerial vehicle (UAV) with a directional antenna can include a tracking module which is configured to be secured relative to a UAV, and which can be configured to operate independently of the UAV. The tracking module may include a processor, a power source, a GPS module, and a transmitter, and may transmit geolocation information of the UAV to a base station. The transmission of geolocation information may occur over a LoRa radio link. The base station may include a processor, a GPS module, a receiver, and one or more movable directional antennas. The orientation of the movable directional antenna may be changed to track the location of the UAV, based on the geolocation information of the UAV and the base station. The directional antennas may replace the antennas of a UAV controller associated with the UAV to increase the operational range of the UAV.

### CROSS-REFERENCE TO RELATED APPLICATIONS

This application claims the benefit under 35 U.S.C. § 119(e) of U.S. Provisional Application No. 62/747,213, filed Oct. 18, 2018, and entitled “DRONE TRACKING STEERED ANTENNA SYSTEM,” the disclosure of which is hereby incorporated by reference in its entirety.

### BACKGROUND

As unmanned aerial vehicle (UAV), or drone, technology progresses, each successive generation is driven by the need for lower costs and greater reliability, particularly in commercial and recreational applications. Additional benefits accrue from reducing weight and complexity of UAV components and systems. Achieving these goals produces additional benefits in the form of greater efficiency as well as increased range and payload capacity.

A critical aspect across all UAV applications is robustness and reliability of communications between the vehicle and its ground station. Often, this entails the use of complex or multiple, relatively massive antennas to provide acceptable three-dimensional (3D) gain. Another approach involves use of antenna steering systems to orient a directional antenna in a preferred alignment for reliable communication. These solutions are at odds with reducing complexity and weight and increasing systems reliability of UAVs.

What is needed are UAV tracking and steering systems, methods and devices. Suitable UAV tracking systems and devices should provide for a base station that points towards a UAV while the UAV is moving to increase communications range.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of the various aspects of this disclosure provide advantages that include improved operational range of UAVs.

Disclosed are UAV tracking and steered antenna systems, methods and devices. The systems, methods and devices use beamforming technologies mounted on a moving system, such as a UAV in communication with an antenna steering system to move the antenna to track the relative movement between a system transmitter and a system receiver. The tracking systems are mounted on the moving UAV while the base stations remain fixed. The tracking system is also configurable to communicate with different base stations. The system provides a mechanical tracking system and active radio link between the UAV and the base station.

The disclosed systems are designed to extend the control and video streaming range of a standard UAV or drone remote controller. This is achievable, for example, by replacing the original antennas in the remote controller by a new set of high gain directional antennas, the whole antennas panel is capable to track the drone geolocation to change the its orientation thus maximizing the communication range.

In one aspect, a UAV tracking system includes two main sub-systems, the first one (a mobile station) is mounted on a surface of the UAV, e.g., on an upper surface, and will be attached to the UAV while the UAV is in flight; the second sub-system is the base station, which remains on ground. Both sub-systems are configurable to have a GPS module, a LoRa radio and a microcontroller. The base station is also configurable to include a servomotor to change the directional antennas orientation.

In one aspect, the basic operation of the system is as follows: a microcontroller on the mobile station reads the GPS location of the drone; the geo-information from the mobile station is transmitted to the base station through, for example, a LoRa radio link; the LoRa radio in the base station reads the received geolocation information; a base station microcontroller reads the geolocation of the base station; the base station microcontroller analyzes a distance between the UAV and the remote controller (base station) at a point in time and determines an optimized angle for the base station antenna; if needed, an instruction is provided to rotate the antenna holder to position the antennas optimally towards the most recent location of the UAV, ensuring the maximum range and best media streaming quality for data received from the UAV.

Once the mentioned values are calculated, the servo mechanism rotates the antenna holder on the base station so that the antennas are positioned relative to the UAV so that the video streaming range and control of the UAV by the base station is extended and optimized.

This loop of determining the geo-information and analyzing the distance between the UAV and the remote controller can be performed every second, although this period can be reduced to improve the tracking.

In one aspect, a system for tracking an unmanned aerial vehicle (UAV) with a directional antenna is described, the system comprising a tracking module configured to be secured relative to a UAV, the tracking module comprising a global satellite positioning module configured to provide information indicative of the location of the tracking module, and a transmitter configured to transmit information indicative of the position of the tracking module, the system also including a base station, comprising a receiver configure to receive from the tracking module information indicative of the position of the tracking module, a global satellite positioning module configured to provide information indicative of the position of the base station; a directional antenna configured to communicate with the UAV; and an orientation control mechanism operably connected to the directional antenna and configured to control the orientation of the directional antenna based at least in part on the information indicative of the positions of the tracking module and the base station.

The orientation control mechanism can include a rotary actuator configured to control a rotational position of the directional antenna. The orientation control mechanism can include a servomotor.

The transmitter of the tracking module can be configured to transmit the information indicative of the position of the tracking module via a Long Range (LoRa) radio link. The tracking module can include a processor operably connected to the global satellite positioning module of the tracking module and the transmitter of the tracking module. The tracking module can additionally include an internal power source.

The tracking module can be configured to function independent of the operation of the UAV. The tracking module can be used without a direct electrical link with the UAV or a direct communication link to the UAV.

The directional antenna of the base station can be configured to transmit signals from a UAV controller associated with the UAV. The base station can be configured to be connected to the UAV controller via at least one wired connection. The base station cam include a processor operably connected to the global satellite positioning module of the base station, the receiver of the tracking module, and the directional antenna. The processor of the base station can be configured to determine an orientation of the directional antenna which will align the directional antenna with the location of the UAV.

In another aspect, a tracking module is described for use in tracking a location of an unmanned UAV, the tracking module configured to be secured relative to the UAV and operate independently of the UAV, the tracking module comprising a global satellite positioning module configured to provide information indicative of the location of the tracking module; a transmitter configured to transmit information to a base station via a Long Range (LoRa) radio link, the information indicative of the position of the tracking module; and a processor operably connected to the global satellite positioning module and the transmitter.

The tracking module can additionally include an internal power source. The tracking module can be configured to be mechanically secured relative to the UAV without forming a direct electrical link with the UAV or a direct communication link with the UAV.

In another aspect, a base station is described for tracking and communicating with an unmanned aerial vehicle (UAV) having a tracking module secured thereto, the base station comprising a receiver configure to receive from the tracking module information indicative of the position of the tracking module; a global satellite positioning module configured to provide information indicative of the position of the base station; and a movable directional antenna configured to communicate with the UAV, wherein the base station is configured to control the orientation of the directional antenna based at least in part on the information indicative of the positions of the tracking module and the base station.

The receiver can be configured to receive the information indicative of the position of the tracking module via a Long Range (LoRa) radio link, and the directional antenna can include a WiFi antenna. The base station can additionally include a servomotor operably connected to the movable directional antenna and configured to control the orientation of the directional antenna based at least in part on the information indicative of the positions of the tracking module and the base station.

The base station can be configured to connect to a UAV controller associated with the UAV and to transmit control instructions generated by the UAV controller to the UAV via the directional antenna. The base station can be configured to receive data from the UAV via the directional antenna.

### BRIEF DESCRIPTION OF THE DRAWINGS

The above-mentioned aspects, as well as other features, aspects, and advantages of the present technology will now be described in connection with various aspects, with reference to the accompanying drawings. The illustrated aspects, however, are merely examples and are not intended to be limiting. Throughout the drawings, similar symbols typically identify similar components, unless context dictates otherwise. Note that the relative dimensions of the following figures may not be drawn to scale.

FIG. 1A is a perspective view of an embodiment of an omni-directional unmanned aerial vehicle (UAV) having a directional antenna.

FIG. 1B is a perspective view of an embodiment of an omni-directional UAV illustrating an exemplary antenna radiation pattern extending therefrom.

FIG. 1C is a portion of a side view of an embodiment of a UAV illustrating an exemplary angle between a surface of the UAV and an antenna extending from the surface of the UAV.

FIG. 2 is an exterior view of an embodiment of a base station housing with electronics, antennas, servomotors and gears positioned on a mounting tripod.

FIG. 3 is an exploded view of an embodiment of a base housing including electronics, antennas, servomotors and gears.

FIG. 4 is a schematic representation of various components of an embodiment of a UAV system including a tracking module and a base station.

FIG. 5A is a perspective view of an embodiment of a tracking module.

FIG. 5B is a perspective view of an embodiment of a tracking module such as the tracking module of FIG. 5A, illustrating interior components of the tracking module.

FIG. 5C is a perspective view of an embodiment of a tracking module such as the tracking module of FIG. 5A, illustrating interior components of the tracking module.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

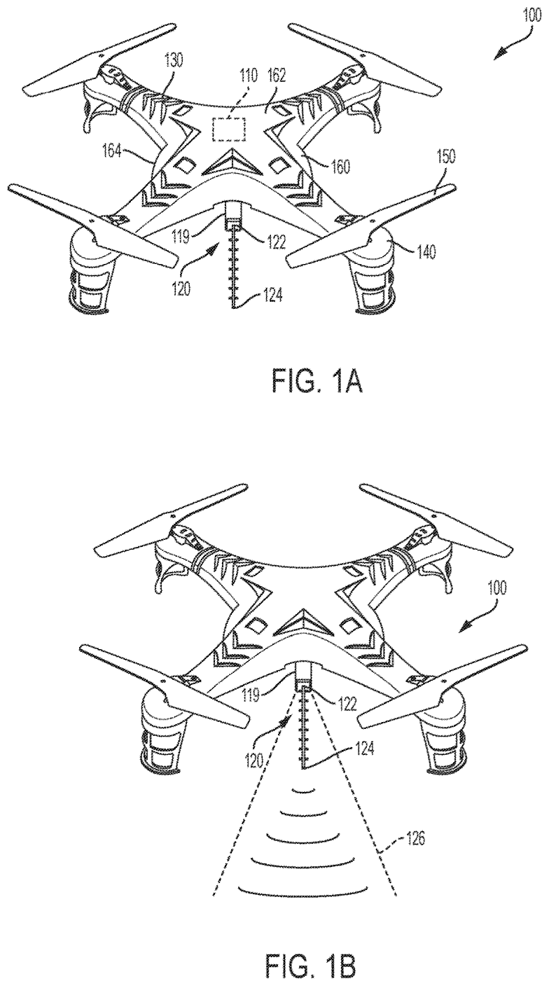

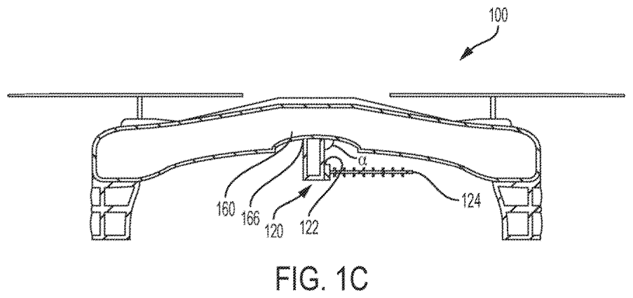

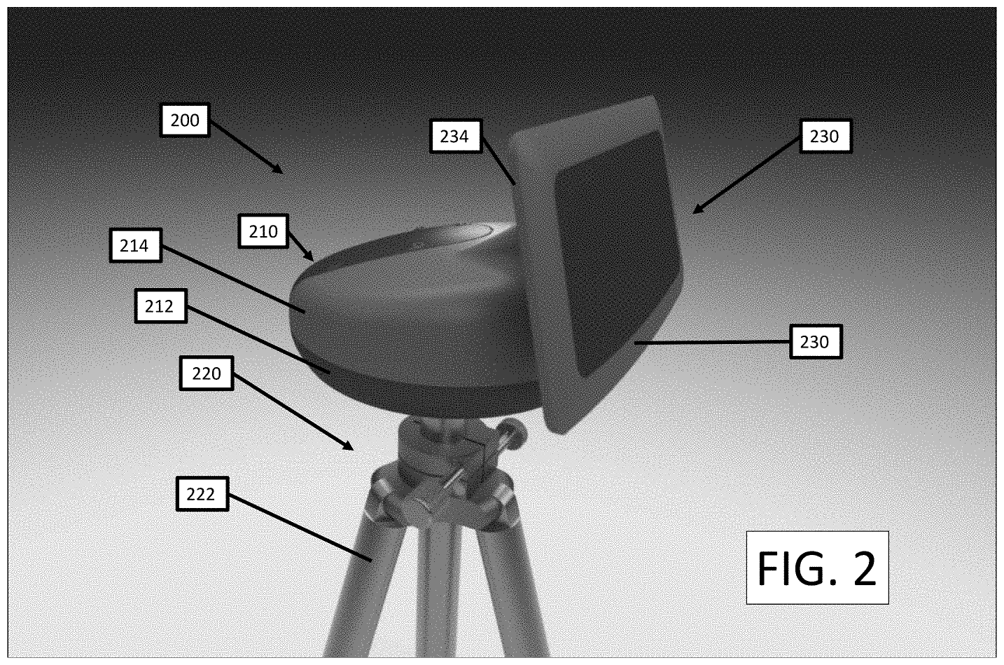

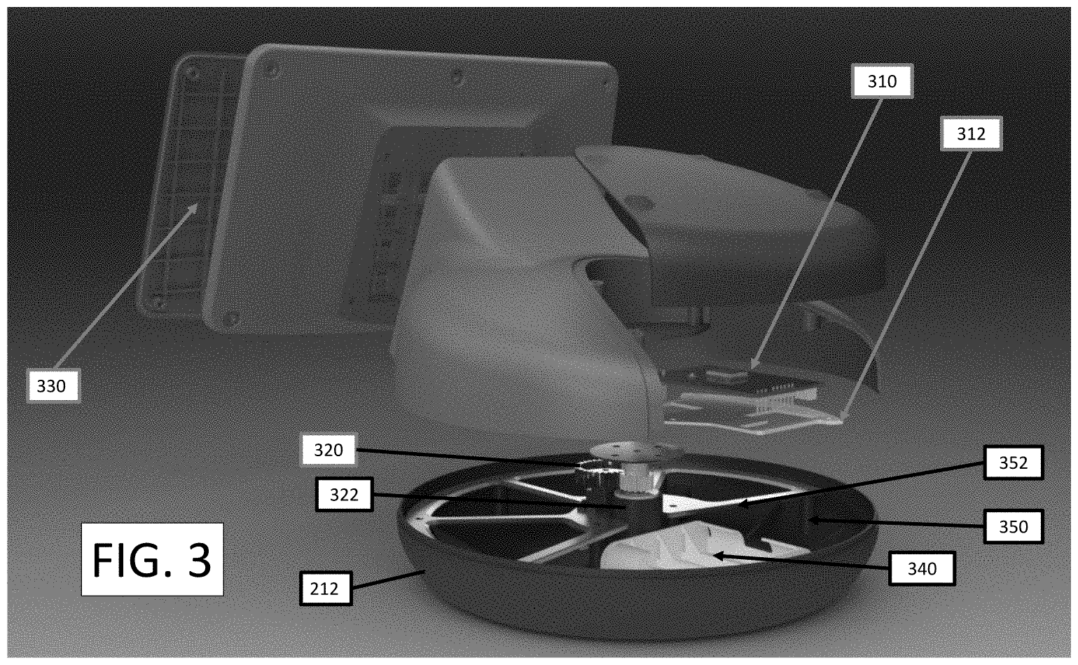

Embodiments of a drone tracking system may have two sub-systems: a mobile station, also referred to herein as a tracking module, and a base station. The mobile station is mounted on a surface of a UAV or otherwise secured relative to the UAV, such as the UAV shown in FIG. 1 and remains attached to the UAV during flying. The base station remains on the ground during operation of the UAV. The base station may include components such as an electronics housing 210 and an antenna holder 230 shown in FIGS. 2-3.

In some embodiments, both the mobile station and the base station include a GPS module, a LoRa (long range, low power) radio and a microcontroller. The base station also includes a servomotor or other orientation control mechanism, which can be used to change the direction of the antennas. An example of such a servo motor is shown in FIG. 3.

A microcontroller on the mobile station can be used to read or obtain a GPS location of the UAV. In embodiments in which the mobile station includes an integrated GPS module, this information can be obtained by the microcontroller from the GPS module. In other embodiments, such as embodiments in which GPS information is made available from the UAV to which the mobile station is attached, the microcontroller may obtain the GPS location from the UAV or another external device.

The mobile station can also include a transmitter to send the geo-information from the microcontroller to the base station via a suitable communications protocol, such as through a LoRa radio link. The base station may include a receiver in or in communication with the base station to receive the LoRa communication. The base station may also include a microcontroller in the base station, which is configured to obtain information indicative of the geolocation of the base station, such as from a GPS module in or in communication with the base station.

With the geolocation of both the mobile station associated with the UAV and the base station, the microcontroller can configurable to calculate a distance between the drone and the remote controller and use the orientation control mechanism to alter the orientation of the antennas in the base station to point towards where the UAV is currently flying. Once the geolocations of the mobile station and the base station are analyzed, the servo mechanism or other orientation control mechanism can be used to alter the orientation of the antennas.

The antenna or antennas in the base station may include directional antennas. Pointing the antennas of the base station toward the UAV ensures a maximum range and a maximum media streaming quality between the UAV and the base station. Analysis of the geolocation can be performed on a periodic basis while the UAV is being operated. Suitable loop periods may include, for example, each half second, each second, every two seconds, every 15 seconds, etc., although a wide variety of additional loop periods both inside and outside of the above range may be used.

In some embodiments, the sampling may be variable, and may be dependent on a variety of factors. For example, the distance and/or relative motion between the UAV and the base station may be taken into account. User settings, or a battery status of the mobile station, may also be taken into account.

In some embodiments, the original antenna of the UAV can be replaced with a suitable antenna system as disclosed herein which is configurable to operate with the base station disclosed. In other embodiments, the mobile station may operate independently of the original antenna of the UAV. Additionally, with the geolocation of both the mobile station associated with the UAV and the base station, the microcontroller is configurable to calculate a distance between the drone and the remote controller, in addition to determining information indicative of a suitable angle at which the antennas in the base station are to be oriented in order to point towards where the UAV is flying.

As shown in FIGS. 1A-C, an exemplary unmanned aerial vehicle 100 of the system includes, for example, a housing having a multi-rotor platform that includes four structural arms 130 extending therefrom and a rotor attached to each of the structural arms 130, thereby forming a omni-directional UAV (Unmanned Aerial Vehicle) or drone. Suitable UAVs include, for example, a quad-copter as illustrated. However, the operation of the mobile terminal may be independent of the operation of the UAV, and the embodiments described herein may be used with a wide variety of UAV configurations without departing from the scope of the disclosure. The UAV may be operable to move along and rotate in three dimensions, including, for example, pitch rotation about a y-axis, yaw rotation about a z-axis, and roll rotation about an x-axis.

Control electronics 110 are integrated into the UAV platform base 160. As illustrated, the UAV platform base 160 has an upper surface 162, four side surfaces 164, and a lower surface 166. These surfaces can be positioned so that the upper surface 162 is parallel to the lower surface 166 and the side surfaces 164 are at least partially perpendicular to a portion of the upper surface 162 and the lower surface 166. Other shapes and configurations for the UAV platform base 160 can be used without departing from the scope of the disclosure. Other configurations of UAV can be used without departing from the scope of the disclosure as will be appreciated by those skilled in the art.

As illustrated, a motor 140 and a propeller 150 are mounted at the end of each of the structural arms 130. Control electronics 110 are configurable to control the speed rates of each motor 140 mounted at the end of each structural arms 130 to cause the movement of the quad-rotor platform.

The antenna 120 generates a signal 126 which emanates from the UAV 100. In some embodiments, the antenna 120 may be a fixed directional antenna. A suitable fixed directional antenna can be a Yagi antenna as illustrated or any other suitable antenna. As will be appreciated by those skilled in the art, the strength of the signal 126 increases as the end of a fixed directional antenna is optimally directed to a base station.

In the illustrated embodiment, the antenna 120 supported by the UAV platform is a single, fixed directional antenna 120 that exhibits superior reception in a preferred orientation. A fixed directional antenna can be positioned so that a first end 122 is configured to engage a surface of the UAV platform base 160 and a second end 124 is at an opposite end from the first end 122. By controlling rotation of the UAV about, for example, its yaw axis, the system orients and maintains the antenna in a preferred azimuth orientation for best reception by a ground control station.

The antenna 120 can be affixed to the UAV platform as a single antenna that is directional or omnidirectional. In the case of an omnidirectional antenna, the UAV may not need to maintain a specific orientation, but the communications distance may be shorter that the case of using a directional antenna.

FIG. 2 is an exterior view of a base station 200 of the drone tracking system according to the disclosure. The base station 200 includes a housing 210 which can include electronic components and other components, and which may be supported on a mounting tripod 220 or other suitable support, or may be a freestanding structure. The housing 210 may be formed from multiple components. In the illustrated embodiment, the housing 210 includes a housing base 212 and a housing cover 214. The electronics housing 210 has an interior cavity which holds at least a portion of the electronics for the base station 200.

The housing 210 engages an antenna holder 230. The antenna holder 230 has an antenna holder front face 232 and an antenna holder rear face 234. The antenna holder rear face 234 engages a surface of the electronics housing 210. As will be appreciated by those skilled in the art, at least a portion of the electronics housing 210 can be formed integrally with the antenna holder 230. In such an embodiment, the antenna holder 230 may be formed as a single piece where the antenna holder rear face 234 is one piece with, or acts as one piece with, a portion of the housing 210 such as the housing cover 214.

In the illustrated embodiment, the mounting tripod 220 includes three tripod legs 222. Additionally, as will be appreciated by those skilled in the art, the mounting tripod can be a mounting device that has one or more legs for engaging the base station 200 and is not limited to a tripod. The mounting device can also include additional components. By way of non-limiting examples, these components may include a center column, a release plate, a ball head, a center column twist lock, multiple-angle leg locks, retractable legs, and a retractable counter weight hook.

FIG. 3 is an exploded view of the base station 200 shown in FIG. 2. The base station may include, among other components, with electronics, antennas, servomotors and gears. The antenna holder 230 houses one or more antennas 330 including, but not limited to, Geolocation Link (LoRa), 2.4 GHz WiFi and 5.8 GHz WiFi. Electronics and a control PCB 310 are provided to communicate between the antennas and the UAV, such as the UAV shown in FIG. 1. As illustrated, the electronics and control PCB 310 may be positioned to be seated on a platform 312, or otherwise supported by a portion of the base station 200.

A battery holder 340 is provided to hold batteries which provide an onboard source of energy to operate the drone tracking system. As will be appreciated by those skilled in the art, other power sources may also be used in place of or in addition to battery power without departing from the scope of the disclosure. Gears 320 and a servomotor 322 are provided which control an orientation of the antennas 330 relative to a UAV. In the illustrate embodiment, an interior rib system 350 is provided within the interior of the housing base 212. The interior rib system 350 has a metal plate 352 positioned on a surface of the interior ribs. The ribs and metal plate provide increased rigidness which reduces vibration of the servomotor when the servomotor is in use.

In some embodiments, the original UAV remote controller and associated software is still used to communicate with and control the UAV. The UAV controller may include original terminal omnidirectional antennas, which may be replaced by the disclosed directional antennas in the drone tracking system. Replacement of the antennas provides an enhanced communications range since the system will rotate the antennas to point them towards the UAV geolocation. The microcontrollers in the system (one in the base station and one affixed to the UAV) may be configured, such as by the use of firmware, to talk between them to share geolocation and calculate the required servomotor rotation.

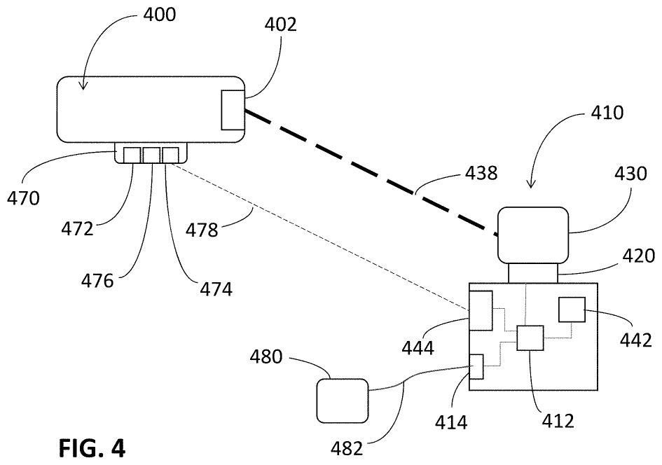

FIG. 4 schematically depicts the various components of a UAV system including a tracking module and a base station.

In the illustrated embodiment, a UAV 400 includes an antenna 402. The antenna 402 may be configured to receive control signals from a controller 480 associated with the UAV 400. The UAV may also include control circuitry, not specifically illustrated in FIG. 4, which can control the operation of the UAV at least partially in response to signals or other information received by the UAV antenna 402.

The UAV 400 also includes a tracking module 470 secured relative to the UAV 400. The tracking module 470 may operate independently of the UAV 400, and may in some embodiments include its own control circuitry 476, such as a microcontroller or other processor. The tracking module 470 may include an independent power source (not shown in FIG. 4) in some embodiments, while in other embodiments, the tracking module 470 may draw power from or share a power source with the UAV 400.

The tracking module 470 may include a global satellite positioning module 472, such as a GPS module. The global satellite positioning module 472 may be used to determine an absolute location of the UAV 400 to which the tracking module 470 is attached. The tracking module 470 may also include a transmitter 476 which can be used to transmit the absolute location of the UAV 400 via a LoRa radio link or other suitable wireless communication protocol.

The tracking module 470 may be permanently or temporarily secured to the UAV 400 by means of any suitable securement method. In some embodiments, one or more adhesive layers may be used to secure the tracking module 470 to the UAV 400. In some embodiments, screws, bolts or other suitable fasteners may be used to secure the tracking module 470 to the UAV 400. In other embodiments, clips, braces, straps, or any other suitable securement components may be used to secure the tracking module 470 to the UAV 400. In some embodiments, an intermediate mount may be used to help secure the tracking module 470 to the UAV 400. For example, a mount or bracket may have a first surface which is shaped and dimensioned to be positioned adjacent a specific UAV 400, and another surface configured to support the tracking module 470.

The system also includes a base station 410. The base station 410 includes a receiver 444 configured to receive information 478 transmitted from the transmitter 476 of the tracking module 470. The information 478 may be transmitted over a LoRa radio link or other suitable wireless communication protocol. The usable range of such a LoRa radio link may be significantly greater than the distance over which a signal can be transmitted from the controller 480 associated with the UAV 400. The base station 410 can receive information via receiver 444 indicative of the current location of the UAV 400.

The base station 410 also includes a global satellite positioning module 442, such as a GPS module, and control circuitry 412 such as a microcontroller or other processor. In addition, the base station 410 includes a directional antenna 430, the orientation of which can be adjusted by an orientation control mechanism 420 such as a servomotor. In some embodiments, the orientation control mechanism 420 can rotate the directional antenna 430 about a rotational axis. In some embodiments, the orientation control mechanism can also adjust an angle of inclination of the directional antenna 430. In such embodiments, at least one of the tracking module 430 and the base station 410 may include an altimeter or other component which can be used to provide an indication of an absolute or relative altitude of the respective tracking module 430 or base station 410.

Based on the information received from the tracking module 470, and the global satellite positioning module 442 of the base station 410, the control circuitry 412 of the base station can determine a desired orientation for the directional antenna 430. For example, the directional antenna 430 can be directed at the most recent location of the UAV 400. This calculation and redirection may be performed on a periodic basis.

The directional antenna 430 may be used to transmit commands from the controller 480 to the UAV antenna 402 as a signal 438. Because the directional antenna 430 is directional and can be maintained in an orientation facing the current location of the UAV 400, the usable range of the directional antenna 430 may be significantly greater than a stock antenna or antennas of the controller 480, which may be omnidirectional in many embodiments. The antenna 403 may also receive information transmitted from the UAV antenna 402. This data may include data or information such as information regarding signal strength, information regarding the status of the UAV, and image, audio, or video data.

In some embodiments, the antenna or antennas of the controller may be connected to the controller using a standard connector, such as an SMA connector. The stock antenna or antennas may be detached, and the connector used to transmit signals to the base station 410. The transmission may be via a wired connection 482 to an input 414 of the base station 410, but in other embodiments, at least part of the connection between the controller 480 and the base station 410 may include a wireless connection. In some embodiments, the base station 410 may serve as a repeater, wirelessly receiving signals from the controller 480 and retransmitting those signals to the UAV 400.

The tracking module 470 and the base station 410 can function as a range extender for control of a UAV 400, extending the usable control range of a UAV 400. Because the tracking module 470 can communicate directly with the base station 410, and can operate independently of the UAV 400, the tracking module can be easily used with a wide variety of suitable UAVs without the need to modify the UAV and without the need for any direct electrical or communicative link between the tracking module 470 and the UAV.

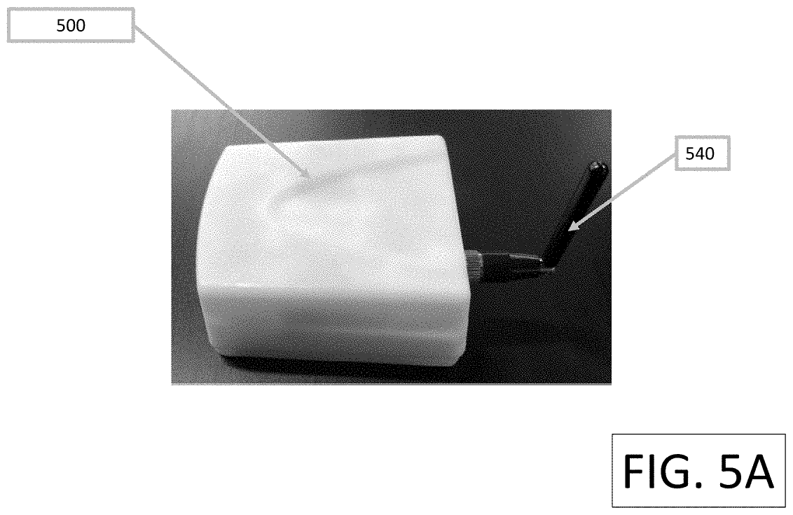

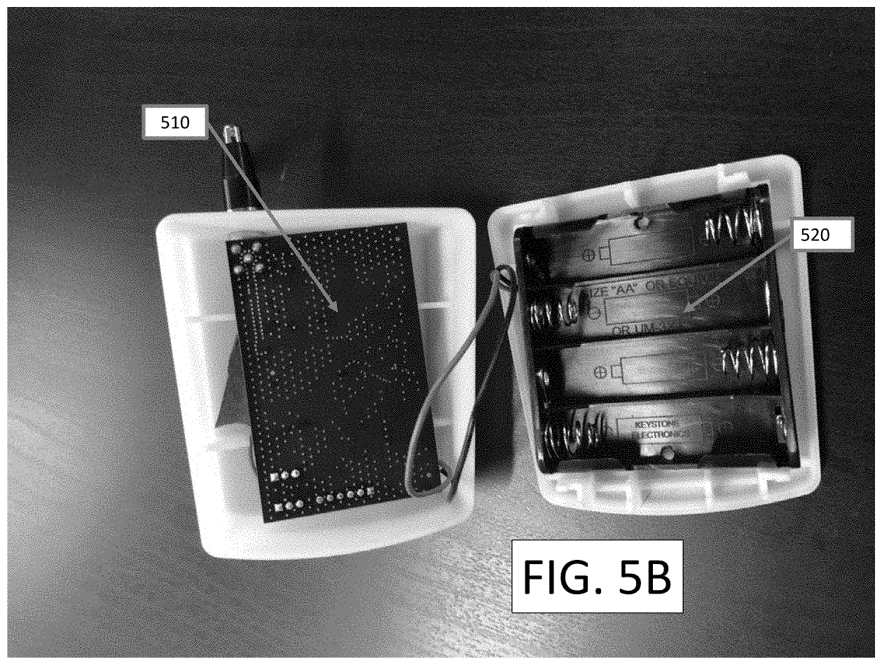

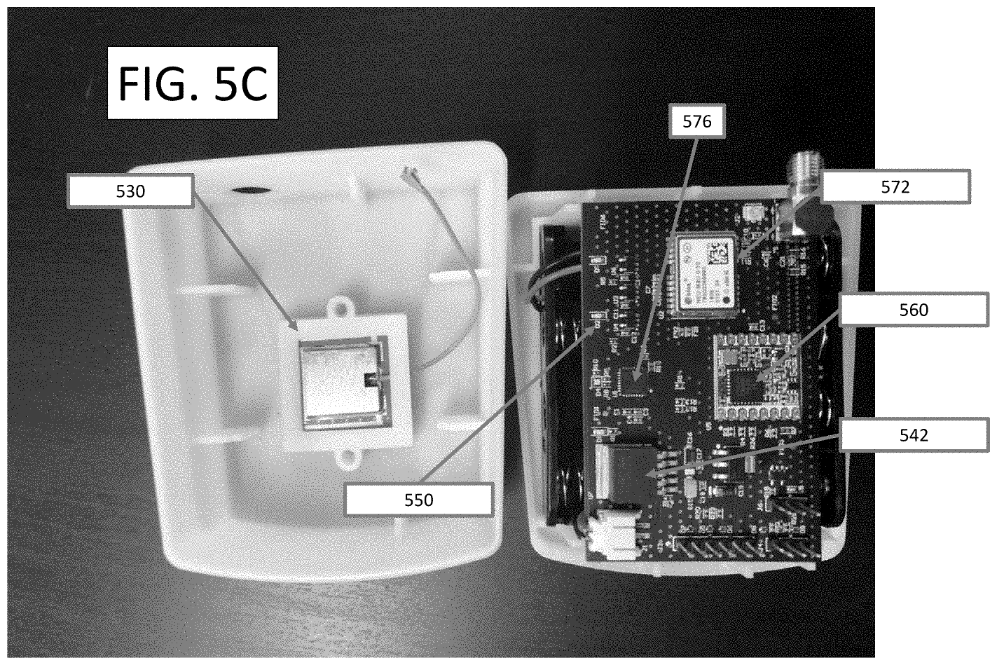

FIG. 5A is a perspective view of an embodiment of a tracking module. FIG. 5B is a perspective view of an embodiment of a tracking module such as the tracking module of FIG. 5A, illustrating interior components of the tracking module. FIG. 5C is a perspective view of an embodiment of a tracking module such as the tracking module of FIG. 5A, illustrating interior components of the tracking module.

In the illustrated embodiment, the tracking module 500 includes an external antenna 540 which may serve as a LoRa antenna or another suitable antenna. The interior of the tracking module includes a battery receptacle 520 which may be connected to a power supply 542 on a printed circuit board (PCB) 510 within the tracking module 500. The PCB 510 also supports a global satellite positioning module 572 such as a GPS module, which may be connected to a GPS antenna 530 supported by an interior surface of the housing of tracking module 500.

The PCB 510 also supports a LoRa module 560 or a similar module for use with a suitable communications protocol. The LoRa module 560 may be connected to the external antenna 540. A microcontroller 576 may also be supported by the PCB 510. An indicator LED 550 may be provided on the PCB and may be visible through the housing of the tracking module 500, and may be used to provide status or connection information to a user.

While certain embodiments of the present invention have been shown and described herein, it will be obvious to those skilled in the art that such embodiments are provided by way of example only. Numerous variations, changes, and substitutions will now occur to those skilled in the art without departing from the invention.

Although particular aspects are described herein, many variations and permutations of these aspects fall within the scope of the disclosure. Although some benefits and advantages of certain aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting.

It should be understood that various alternatives to the embodiments described herein may be employed. The detailed description and drawings are merely illustrative of the disclosure rather than limiting, the scope of the disclosure being defined by the appended claims and equivalents thereof.

What is claimed is:

1. A system for tracking an unmanned aerial vehicle (UAV) with a directional antenna, the system comprising:
a tracking module configured to be secured relative to a UAV, the tracking module comprising:
a global satellite positioning module configured to provide information indicative of the location of the tracking module; and
a transmitter configured to transmit information indicative of the position of the tracking module; and
a base station, comprising:
a receiver configure to receive from the tracking module information indicative of the position of the tracking module;
a global satellite positioning module configured to provide information indicative of the position of the base station;
a directional antenna configured to communicate with the UAV; and
an orientation control mechanism operably connected to the directional antenna and configured to control the orientation of the directional antenna based at least in part on the information indicative of the positions of the tracking module and the base station.

2. The system of claim 1, wherein the orientation control mechanism comprises a rotary actuator configured to control a rotational position of the directional antenna.

3. The system of claim 2, wherein the orientation control mechanism comprises a servomotor.

4. The system of claim 1, wherein the transmitter of the tracking module is configured to transmit the information indicative of the position of the tracking module via a Long Range (LoRa) radio link.

5. The system of claim 1, wherein the tracking module comprises a processor operably connected to the global satellite positioning module of the tracking module and the transmitter of the tracking module.

6. The system of claim 1, wherein the tracking module additionally comprises an internal power source.

7. The system of claim 1, wherein the tracking module is configured to function independent of the operation of the UAV.

8. The system of claim 1, wherein the tracking module does not have a direct electrical link with the UAV or a direct communication link to the UAV.

9. The system of claim 1, wherein the directional antenna of the base station is configured to transmit signals from a UAV controller associated with the UAV.

10. The system of claim 9, wherein the base station is configured to be connected to the UAV controller via at least one wired connection.

11. The system of claim 1, wherein the base station comprises a processor operably connected to the global satellite positioning module of the base station, the receiver of the tracking module, and the directional antenna.

12. The system of claim 11, wherein the processor of the base station is configured to determine an orientation of the directional antenna which will align the directional antenna with the location of the UAV.

13. A tracking module for use in tracking a location of an unmanned UAV, the tracking module configured to be secured relative to the UAV and operate independently of the UAV, the tracking module comprising:
a global satellite positioning module configured to provide information indicative of the location of the tracking module;
a transmitter configured to transmit information to a base station via a Long Range (LoRa) radio link, the information indicative of the position of the tracking module; and
a processor operably connected to the global satellite positioning module and the transmitter.

14. The tracking module of claim 1, wherein the tracking module additionally comprises an internal power source.

15. The tracking module of claim 1, wherein the tracking module is configured to be mechanically secured relative to the UAV without forming a direct electrical link with the UAV or a direct communication link with the UAV.

16. A base station for tracking and communicating with an unmanned aerial vehicle (UAV) having a tracking module secured thereto, the base station comprising:
a receiver configure to receive from the tracking module information indicative of the position of the tracking module;
a global satellite positioning module configured to provide information indicative of the position of the base station; and
a movable directional antenna configured to communicate with the UAV, wherein the base station is configured to control the orientation of the directional antenna based at least in part on the information indicative of the positions of the tracking module and the base station.

17. The base station of claim 16, wherein the receiver is configured to receive the information indicative of the position of the tracking module via a Long Range (LoRa) radio link, and wherein the directional antenna comprises a WiFi antenna.

18. The base station of claim 16, wherein the base station additionally comprises a servomotor operably connected to the movable directional antenna and configured to control the orientation of the directional antenna based at least in part on the information indicative of the positions of the tracking module and the base station.

19. The base station of claim 16, wherein the base station is configured to connect to a UAV controller associated with the UAV and to transmit control instructions generated by the UAV controller to the UAV via the directional antenna.

20. The base station of claim 16, wherein the base station is configured to receive data from the UAV via the directional antenna.
